(19) United States
(12) Patent Application Publication
(10) Pub. No.: US 2013/0330581 A1
(43) Pub. Date: Dec. 12, 2013

(54) SECONDARY BATTERY

(71) Applicants: SAMSUNG SDI CO., LTD., Yongin-si (KR); ROBERT BOSCH GMBH, Stuttgart (DE)

(72) Inventors: Dukjung KIM, Yongin-si (KR); Jeongwon OH, Yongin-si (KR); Hyungsik KIM, Yongin-si (KR); Zin PARK, Yongin-si (KR); Jaeik KWON, Yongin-si (KR); Minhyung GUEN, Yongin-si (KR)

(73) Assignees: ROBERT BOSCH GMBH, Stuttgart (DE); SAMSUNG SDI CO., LTD., Yongin-si (KR)

(21) Appl. No.: 13/751,706

(22) Filed: Jan. 28, 2013

(30) Foreign Application Priority Data
Jun. 7, 2012 (KR) 10-2012-0060969

(51) Int. Cl. H01M 2/34; H01M 2/30

(52) U.S. Cl. CPC H01M 2/345; H01M 2/30
USPC 429/61; 429/179

(57) ABSTRACT

A secondary battery includes an electrode assembly including a first electrode plate, a second electrode plate, and a separator therebetween, a first collector plate and a second collector plate electrically connected to the first electrode plate and the second electrode plate, respectively, a case accommodating the electrode assembly, the first collector plate and the second collector plate; a cap plate sealing the case, a first electrode terminal and a second electrode terminal electrically connected to the first collector plate and the second collector plate and penetrating the cap plate, a first coupling terminal spaced apart from an outside of the cap plate and electrically connected to the first electrode terminal, and a first upper insulation member between the cap plate and the first coupling terminal, the first upper insulation member including a first grip recess extending lengthwise at opposite sides of the first upper insulation member.

### CROSS-REFERENCE TO RELATED APPLICATION

This application claims the benefit under 35 U.S.C. §119 of Korean Patent Application No. 10-2012-0060969, filed on Jun. 7, 2012, in the Korean Intellectual Property Office, and entitled “Secondary Battery,” the disclosure of which is incorporated by reference herein in its entirety.

### BACKGROUND

1. Field

Embodiments relate to a secondary battery.

2. Description of the Related Art

Unlike a primary battery which cannot be recharged, a secondary battery can be repeatedly charged and discharged. Low capacity batteries that use single battery cells are used as power sources for various portable small-sized electronic devices such as cellular phones and camcorders. High power batteries that use tens of battery cells connected to each other in a battery pack are used as power sources for electric scooters, hybrid vehicles, or electric vehicles.

The secondary battery may be classified into different types, such as cylindrical and prismatic batteries. The secondary battery is generally configured by accommodating an electrode assembly (having a positive plate and a negative plate and a separator as an insulator interposed therebetween) inside a case with an electrolyte and installing a cap plate on the case. A positive terminal and a negative terminal are connected to the electrode assembly and protrude outwardly through the cap plate to be exposed.

### SUMMARY

Embodiments are directed to a secondary battery including an electrode assembly including a first electrode plate, a second electrode plate, and a separator interposed between the first electrode plate and the second electrode plate, a first collector plate and a second collector plate electrically connected to the first electrode plate and the second electrode plate, respectively, a case accommodating the electrode assembly, the first collector plate and the second collector plate, a cap plate sealing the case, a first electrode terminal and a second electrode terminal respectively electrically connected to the first collector plate and the second collector plate and penetrating the cap plate, a first coupling terminal spaced apart from an outside of the cap plate and electrically connected to the first electrode terminal, and a first upper insulation member provided between the cap plate and the first coupling terminal, the first upper insulation member including a first grip recess extending lengthwise at opposite sides of the first upper insulation member.

The first upper insulation member may include a bottom part and sidewalls extending from edges of the bottom part toward the first coupling terminal. An upper surface of the bottom part of the first upper insulation member may have at least one protrusion part formed thereon.

The cap plate may include a short-circuit hole and a short-circuit plate installed in the short-circuit hole. The bottom part of the first upper insulation member may include an electrode terminal hole through which the first electrode terminal passes and an opening hole corresponding to the short-circuit plate.

The first coupling terminal may include a coupling part coupled to the first electrode terminal, and includes an extension part extending from the coupling part so as to be adjacent to the short-circuit plate. At least one guide groove may be formed at at least one opposite side of the coupling part, and the protrusion part at the upper surface of the bottom part of the first insulation member is engaged with the guide groove.

The secondary battery may further include a cover part provided to cover the extension part.

The first grip recess may be located at each of the sidewalls in a lengthwise direction of the first upper insulation member. A cross-sectional shape of the first grip recess may be one selected from a polygon, a circle, and a semi-circle with respect to the lengthwise direction of the first upper insulation member. The first grip recess may be located at a region where the sidewall and the bottom part contact each other in the lengthwise direction of the first upper insulation member.

The first upper insulation member may include one selected from polypropylene (PP), polyethylene (PE), polyvinyl chloride (PVC), urethane, nylon and PTFE.

The secondary battery may further include a second coupling terminal spaced apart from the cap plate and coupled to the second electrode terminal. The secondary battery may further include a second upper insulation member between the cap plate and the second coupling terminal. The second coupling terminal may have a second grip recess located at opposite sides of the second coupling terminal in a same direction in which the first grip recess is formed.

The first upper insulation member and the second upper insulation member may include one selected from polypropylene (PP), polyethylene (PE), polyvinyl chloride (PVC), urethane, nylon, and PTFE.

Embodiments are also directed to a secondary battery including an electrode assembly including a first electrode plate, a second electrode plate, and a separator interposed between the first electrode plate and the second electrode plate, a first collector plate and a second collector plate electrically connected to the first electrode plate and the second electrode plate, respectively, a case accommodating the electrode assembly, the first collector plate and the second collector plate, a cap plate sealing the case, a first electrode terminal and a second electrode terminal respectively electrically connected to the first collector plate and the second collector plate and penetrating the cap plate, a first coupling terminal spaced apart from the cap plate and electrically connected to the first electrode terminal, and a first upper insulation member between the cap plate and the first coupling terminal, the first upper insulation member including a grip protrusion part extending lengthwise at both sides of the first upper insulation member.

The first upper insulation member may include a bottom part, and sidewalls extending from edges of the bottom part in a first direction.

The grip protrusion part may outwardly protrude from a top end of the sidewall and may be perpendicular to the lengthwise direction.

### BRIEF DESCRIPTION OF THE DRAWINGS

Features will become apparent to those of skill in the art by describing in detail exemplary embodiments with reference to the attached drawings in which:

FIG. 1 illustrates a perspective view of a secondary battery according to an embodiment;

FIG. 2 illustrates a cross-sectional view of the secondary battery taken along the line I-I′ of FIG. 1;

FIG. 3A illustrates an enlarged cross-sectional view of an ‘A’ region of FIG. 2, and FIG. 3B is a cross-sectional view of the secondary battery taken along the line II-II′ of FIG. 1;

FIG. 4A illustrates a side view of the secondary battery viewed from an L side of FIG. 1, and FIG. 4B is a side view of the secondary battery viewed from an R side of FIG. 1;

FIG. 5A illustrates a perspective view of an upper insulation member of the secondary battery shown in FIG. 1, and FIG. 5B illustrates an exploded perspective view showing connections between the upper insulation member, a coupling terminal, and a cover shown in FIG. 5; and

FIG. 6A illustrates a perspective view of an upper insulation member of a secondary battery according to another embodiment, and FIG. 6B illustrates an exploded perspective view showing connections between the upper insulation member, a coupling terminal, and a cover shown in FIG. 6A.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when a element is referred to as being “between” two elements, it can be the only element between the two other elements, or one or more intervening elements may also be present. Like reference numerals refer to like elements throughout.

Spatially relative terms, such as “lower,” “upper,” and the like, may be used herein for ease of description to describe one element or feature relationship to another element or feature as illustrated in the figures. It will be understood that the spatially relative terms are intended to encompass different orientations of the device in use or operation in addition to the orientation depicted in the figures. Similarly, spatial terms such as “horizontally,” “vertically,” etc., may be understood in the context of the drawings. Herein, the terms “length” and “lengthwise” refer generally to a horizontal direction parallel to the longest side of the secondary battery, for example, in a direction between electrode terminals.

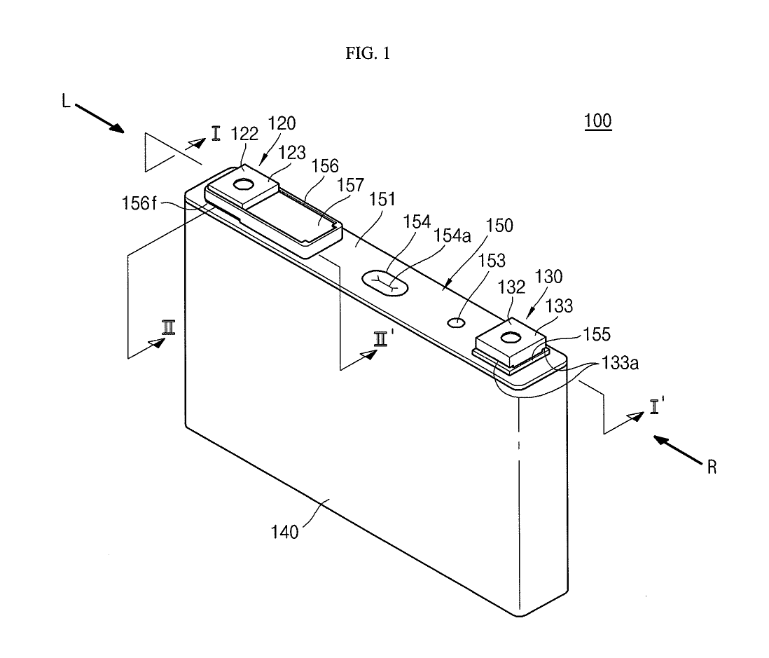

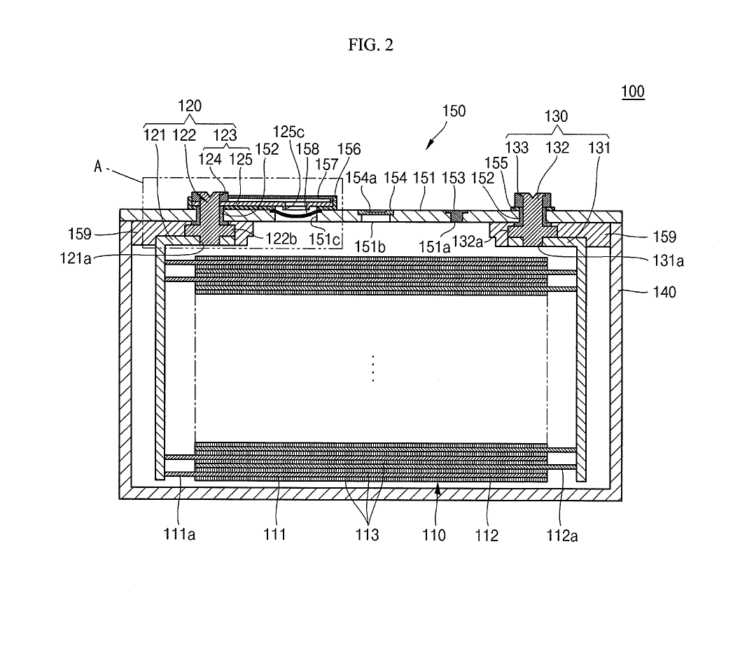

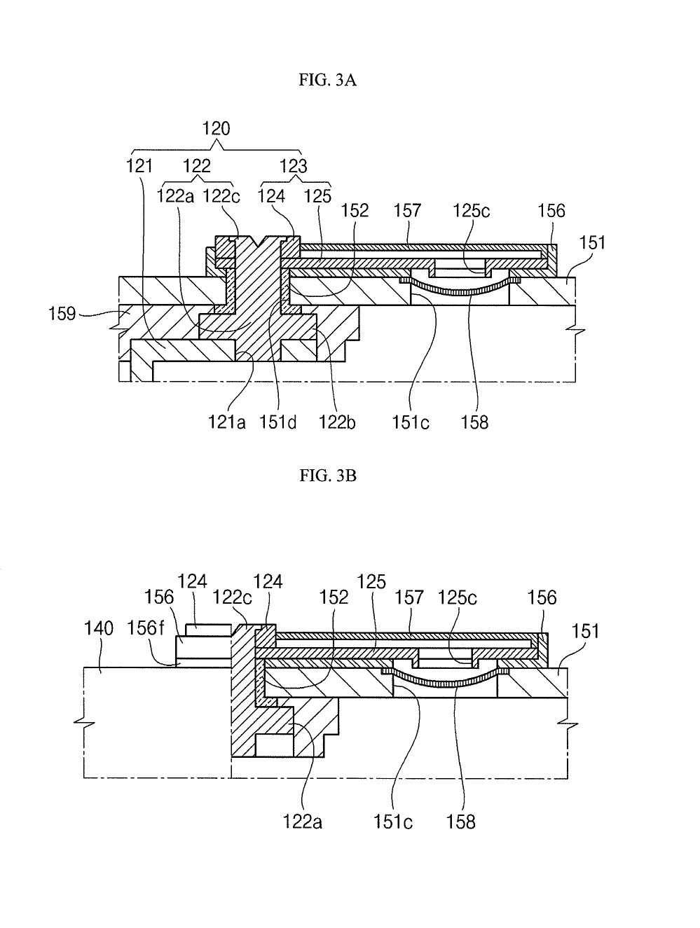

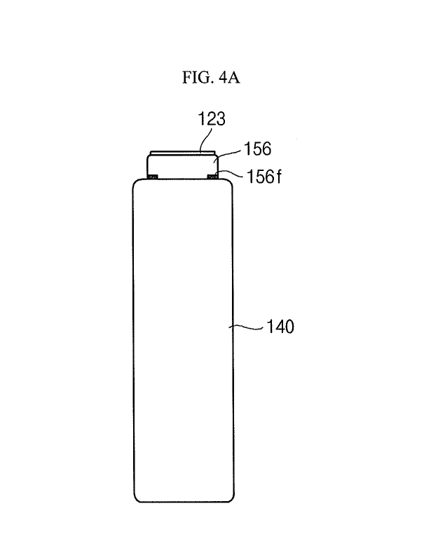

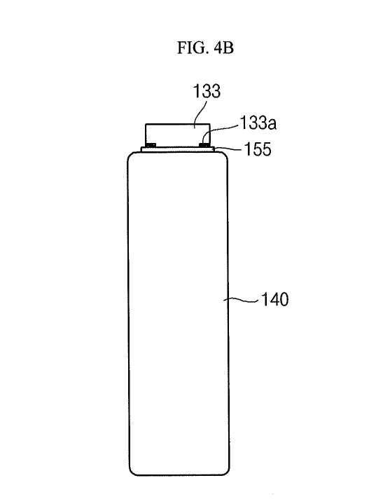

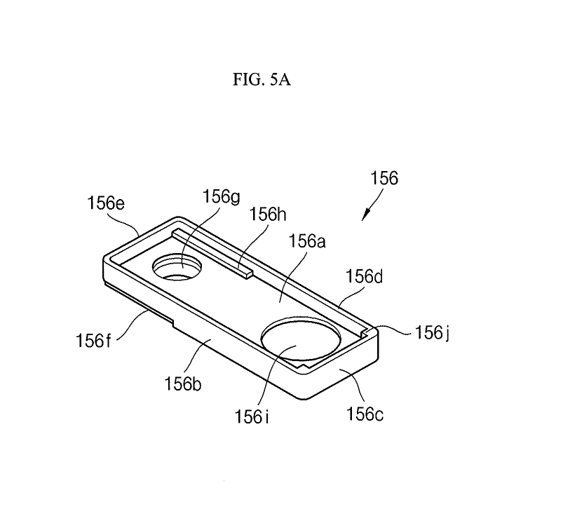

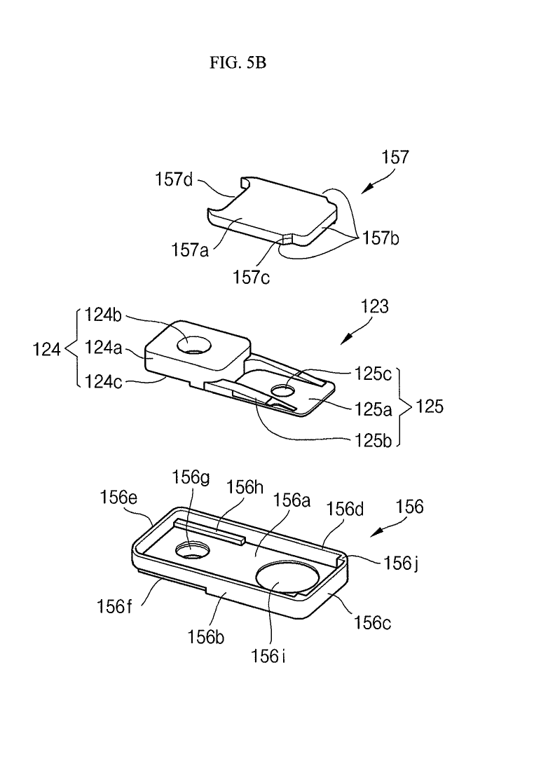

FIG. 1 illustrates a perspective view of a secondary battery according to an embodiment. FIG. 2 illustrates a cross-sectional view of the secondary battery taken along the line I-I′ of FIG. 1. FIG. 3A illustrates an enlarged cross-sectional view of an ‘A’ region of FIG. 2. FIG. 3B illustrates a cross-sectional view of the secondary battery taken along the line II-II′ of FIG. 1. FIG. 4A illustrates a side view of the secondary battery viewed from an L side of FIG. 1. FIG. 4B illustrates a side view of the secondary battery viewed from an R side of FIG. 1. FIG. 5A illustrates a perspective view of an upper insulation member of the secondary battery shown in FIG. 1, and FIG. 5B illustrates an exploded perspective view showing connections between the upper insulation member, a coupling terminal, and a cover shown in FIG. 5.

Referring to FIGS. 1 to 5B, the secondary battery 100 includes an electrode assembly 110, a first terminal part 120, a second terminal part 130, a case 140, and a cap assembly 150.

The electrode assembly 110 may be formed by winding or laminating a stacked structure having a first electrode plate 111, a separator 113, and a second electrode plate 112, which are formed of a thin plate or layer. The first electrode plate 111 may function as a negative electrode, and the second electrode plate 112 may function as a negative electrode, or vice versa.

The first electrode plate 111 may be formed by applying a first electrode active material, such as graphite or carbon, on a first electrode collector plate formed of a metal foil, such as nickel or copper foil. Other suitable materials may be used for the first electrode active material and first electrode collector plate. The first electrode plate 111 may include a first electrode uncoated portion 111a on which the first electrode active metal is not applied. The first electrode uncoated portion 111a may function as a passage for current flowing between the first electrode plate 111 and the outside of the first electrode plate 111.

The second electrode plate 112 may be formed by applying a second electrode active material, such as a transition metal, on a second electrode collector plate formed of a metal foil, such as aluminum foil. The second electrode plate 112 may include a second electrode uncoated portion 112a on which the second electrode active metal is not applied. The second electrode uncoated portion 112a may function as a passage for current flowing between the second electrode plate 112 and the outside of the second electrode plate 112. Other suitable materials may be used for the second electrode active material and second electrode collector plate. In other implementations, the relative polarities and materials of the first and second electrode plates 111 and 112 may differ from what is described above.

The separator 113 may be disposed between the first electrode plate 111 and the second electrode plate 112 to prevent short circuiting and to allow the movement of lithium ions. The separator 113 may be formed of a suitable material such as polyethylene, polypropylene, or a combined film of polypropylene and polyethylene.

The electrode assembly 110 and electrolyte are accommodated within the case 140. The electrolyte may include an organic solvent such as one or more of ethylene carbonate (EC), propylene carbonate (PC), diethyl carbonate (DEC), ethyl methyl carbonate (EMC), or dimethyl carbonate (DMC), and a lithium salt such as LiPF₆ or LiBF₄. The electrolyte may be a liquid, a solid, or a gel.

The first terminal part 120 and the second terminal part 130 electrically connected to the first electrode plate 111 and the second electrode plate 112, respectively, may be coupled to both ends of the electrode assembly 110. The first terminal part 120 may be formed of a metal or an equivalent thereof, and may be electrically connected to the first electrode plate 111. The first terminal part 120 may include a first collector plate 121, a first electrode terminal 122, and a first coupling terminal 123.

The first collector plate 121 may contact the first electrode uncoated portion 111a protruding from an end of the electrode assembly 110. The first collector plate 121 may be welded to the first electrode uncoated portion 111a. The first collector plate 121 may be approximately ‘L’ shaped, and a terminal hole 121a may be formed in the upper portion thereof The first electrode terminal 122 may be fitted into and coupled to the terminal hole 121 a. The first collector plate 121 may be formed of, for example, copper, a copper alloy, or an equivalent thereof, as examples.

The first electrode terminal 122, passing through the cap plate 151, may protrude upwardly by a predetermined length and may be electrically connected to the first collector plate 121 at a lower side of the cap plate 151. The first electrode terminal 122 may be formed of any suitable material, such as aluminum, an aluminum alloy, or an equivalent thereof, as examples.

The first electrode terminal 122 may include a first body part 122a, a first flange 122b, and a first fixing part 122c.

The first body part 122a may be divided into an upper pillar protruding to an upper portion of the cap plate 151 and a lower pillar connected to a lower portion of the upper pillar and extending to a lower portion of the cap plate 151. The first body part 122a may have, for example, a cylindrical shape.

The first flange 122b may extend horizontally from a side part of the lower pillar of the first body part 122a. The first flange 122b may prevent the first electrode terminal 122 from being dislodged from the cap plate 151. A portion of the lower pillar of the first body part 122a, which is connected to the lower portion of the first flange 122b, may be fitted into the first terminal hole 121a of the first collector plate 121 and then welded.

The first fixing part 122c may horizontally extend from a side part of the upper pillar of the first electrode terminal 122. The first fixing part 122c may fix the first electrode terminal 122 to the first coupling terminal 123. The first fixing part 122c may be formed by riveting an end of the upper pillar of the first electrode terminal 122.

The first coupling terminal 123 may be disposed to be spaced apart from the upper portion of the cap plate 151. The first coupling terminal 123 may be disposed to be coupled to an upper insulation member 156 disposed on a top surface of the cap plate 151. In addition, the first coupling terminal 123 may be coupled to the first electrode terminal 122 while the upper pillar of the first electrode terminal 122 passes through the first coupling terminal 123. The first coupling terminal 123 may be formed to overlap a short-circuit plate 158 formed in the cap plate 151. To this end, the first coupling terminal 123 may include a first coupling part 124 and a first extension part 125. The first coupling part 124 and the first extension part 125 may be integrally formed. The first coupling part 124 may be formed to be higher than the first extension part 125. The first coupling terminal 123 may be coupled to the first electrode terminal 122 through the first coupling part 124 and may be electrically insulated from the cap plate 151 by the first upper insulation member 156. Short circuiting between the first coupling terminal 123 and the short-circuit plate 158 that is inverted and upwardly protrudes, which may be caused when an internal pressure of the secondary battery 100 exceeds a predefined pressure, may occur through the first extension part 125 of the first coupling terminal 123. If the short circuiting is caused, a high current flows through the secondary battery 100, so that heat may be generated. In this case, a fuse part (not shown) formed in the first electrode terminal 122 or the second electrode terminal 132 may be melted to break the current flow, thereby achieving safety of the secondary battery 100. The first coupling terminal 123 may be formed of any suitable material, such as copper, a copper alloy, aluminum, an aluminum alloy, or an equivalent thereof.

The first coupling part 124 may have an approximately rectangular pillar shape and may include a first coupling body part 124a, a first terminal penetration hole 124b, and a first guide groove 124c.

The first coupling body part 124a may be a part contacting the first upper insulation member 156 and may serve as a base allowing the first coupling part 124 to be securely mounted in the first upper insulation member 156.

The first terminal throughhole 124b may be formed vertically from a top surface to a bottom surface of the first coupling body part 124a and may provide a space for allowing the upper pillar of the first electrode terminal 122 to pass.

The first guide groove 124c may be formed on a bottom surface of a side of the first coupling body part 124a and may be coupled to a protrusion part 156h formed in the first upper insulation member 156. The first guide groove 124c may prevent the first coupling terminal 123 from rotating when the first electrode terminal 122 is coupled to the first coupling terminal 123. In order to establish coupling of the first guide groove 124c and the protrusion part 156h, the first guide groove 124c may be shaped to correspond to the protrusion part 156h.

The first extension part 125 may extend horizontally from lower exterior edges of the first coupling body part 124a so as to cover the short-circuit plate 158. The first extension part 125 may include a bottom part 125a, opposite sidewalls 125b protruding on opposite surfaces of the bottom part 125a, and a support part 125c protruding downwardly at a region corresponding to the short-circuit plate 156 of the bottom part 125a. The support part 125c may be shaped as a hollow cylinder. An inner diameter of the support part 125c may be smaller than a diameter of the short-circuit hole 151c formed in the cap plate 151. Therefore, the support part 125a may allow the inverted short-circuit plate 158 to make contact with the edges of the support part 125c. The support part 125c may allow the short-circuit plate 158 to make contact with the first extension part 125 with an increased area, thereby facilitating short circuiting between the short-circuit plate 158 and the first extension part 125 when the internal pressure of the secondary battery 100 exceeds the predefined pressure. In addition, the opposite sidewalls 125b may support the cover part 157 in a state in which the first extension part 125 and the cover part 157 are engaged with each other. The opposite sidewalls 125b may be formed to have a sufficient height to allow the top surface of the opposite sidewalls 125b to contact a bottom surface of the cover part 157. In other implementations, the sidewalls 125b and the cover part 157 may be spaced apart from each other.

Like the first terminal part 120, the second terminal part 130 may be generally formed of a metal, or an equivalent thereof, and may be electrically connected to the second electrode plate 112. The second terminal part 130 may include a second collector plate 131, a second electrode terminal 132, and a second coupling terminal 133.

The second collector plate 131 may contact the second electrode uncoated portion 112a protruding from the other end of the electrode assembly 110. Substantially, the second collector plate 131 may be welded to the second electrode uncoated portion 112a. The second collector plate 131 may be approximately ‘L’ shaped, and a terminal hole 131a may be formed in the upper portion thereof. The second electrode terminal 132 may be fitted into and coupled to the terminal hole 131a. The second collector plate 131 may be formed of, for example, aluminum, an aluminum alloy, or an equivalent thereof.

The second electrode terminal 132, passing through the cap plate 151, may protrude upwardly by a predetermined length and may be electrically connected to the second collector plate 131 at a lower side of the cap plate 151. The second electrode terminal 132 may be formed of any suitable material, such as aluminum, an aluminum alloy, or an equivalent thereof. The second electrode terminal 132 may have a shape symmetrical to that of the first electrode terminal 122 in view of the cap plate 151, and a detailed description thereof will not be repeated.

The second coupling terminal 133 may be disposed on the upper portion of the cap plate 151. The second coupling terminal 133 may be formed to allow the second electrode terminal 132 to pass through the same to then be coupled to the second coupling terminal 133. The second coupling terminal 133 may have an approximately rectangular pillar shape. The second coupling terminal 133 may be electrically and mechanically connected to the second electrode terminal 132.

The second upper insulation member 155 may be formed such that the second electrode terminal 132 passes through a portion between the second coupling terminal 133 and the cap plate 151. To this end, the second upper insulation member 155 may have a throughhole through which the second coupling terminal 133 passes.

The second coupling terminal 133 may have a second grip recess 133a having a predetermined depth formed at opposite sides of the second electrode terminal 132. The second grip recess 133a of the second coupling terminal 133 may be formed lengthwise at opposite sides of the second electrode terminal 132 and may be adjacent to the second upper insulation member 155. The second grip recess 133a may be formed at a side in the same direction in which a first grip recess 156f of the first upper insulating member 156 is formed. In general, during an assembling process of a secondary battery, a cell surface or a terminal part of the secondary battery may be pressed and gripped using a gripping device provided in a transfer device, such as a robot, to be transferred in various assembling process steps. In some cases, the gripped cell surface or the terminal part of secondary battery may be damaged. Therefore, according to embodiments, the second grip recess 133a is formed at the sidewall of the second coupling terminal 133 such that the cell may be conveniently gripped using a transfer device, such as a robot, and then be transferred to a desired position, thereby improving working efficiency and preventing damage to the secondary battery. For example, in the manufacture of a secondary battery, in order to apply a predetermined coating material to an external surface of the case 140, a cell may be conveniently gripped by a transfer device, such as a robot, and then transferred to a space in which the applying of the coating material is performed. The second grip recess 133a may have any suitable cross-sectional shape, for example, a cross-sectional shape of a rectangle, a triangle, a circle or a semi-circle, as long as the second coupling terminal 133 can be gripped by the gripping device provided in the transfer device, such as a robot. The gripping device may press the cell in a widthwise direction of the second grip recess 133a to transfer the cell to a desired position.

The case 140 may be formed of a conductive metal, such as aluminum, an aluminum alloy or nickel plated steel. The case 140 may be approximately hexahedron shaped and may be provided with an opening through which the electrode assembly 110, the first terminal part 120 and the second terminal part 130 are inserted and placed. Since the case 140 and the cap assembly 150 are illustrated in an assembled state in FIG. 2, the opening of the case 140 is not shown. It is to be understood that the opening corresponds to a substantially opened portion of the edge of the cap assembly 150. The inner surface of the case 140 may be treated to be insulated from the electrode assembly 110, the first and second terminal parts 120 and 130, and the cap assembly 150.

The cap assembly 150 may be coupled to the case 140. In detail, the cap assembly 150 may include the cap plate 151, seal gaskets 152, a plug 153, a safety vent 154, the first upper insulation member 156, the second upper insulation member 155, a cover part 157, and a lower insulation member 159.

The cap plate 151 closes the opening of the case 140. The cap plate 151 may be formed of the same material as that of the case 140. The cap plate 151 may have an electrolyte injection hole 151a, a vent hole 151b, a short-circuit hole 151c and an electrode terminal hole 151d. The cap plate 151 may be coupled to the case 140 through laser welding, as an example. The cap plate 151 may have the same polarity as the first electrode plate 111 and the first terminal part 120. The case 140 and the cap plate 151 may have the same polarity.

The seal gaskets 152 may be formed of an insulating material and may be disposed between the cap plate 151 and the first and second electrode terminals 122 and 132 to seal the space between the cap plate 151 and the first and second electrode terminals 122 and 132. The seal gaskets 152 may help to prevent the introduction of moisture into the secondary battery 100 or the leakage of the electrolyte from the secondary battery 100.

The plug 153 may close an electrolyte injection hole 151a of the cap plate 151. The safety vent 154 may be installed in a vent hole 151b of the cap plate 151 and may have a notch 154a to be opened at a set pressure.

The first upper insulation member 156 may be disposed to accommodate the first coupling terminal 123 between the cap plate 151 and the first coupling member 123. To this end, the first upper insulation members 156 may include a bottom part 156a, a first sidewall 156b, a second sidewall 156c, a third sidewall 156d and a fourth sidewall 156e. In addition, the first upper insulation member 156 may include the first grip recess 156f, an electrode terminal hole 156g, the first protrusion part 156h, a first opening hole 156i and a vertical protrusion part 156j.

The bottom part 156a of the first upper insulation member 156 may tightly contact the cap plate 151 and may serve as a base allowing the first upper insulation member 156 to be securely mounted in the cap plate 151.

The first to fourth sidewalls 156b to 156e may be formed to upwardly extend from edges of the bottom part 156a (that is, toward the first coupling terminal 123) and may substantially provide a space where the first coupling terminal 123 is accommodated in the first upper insulation member 156. The first coupling part 124 and the first extension part 125 of the first coupling terminal 123 may be accommodated in an accommodation space formed by the bottom part 156a and the first to fourth sidewalls 156b to 156e. The accommodation space may be shaped to correspond to and accommodate the first coupling part 124 and the first extension part 125 of the first coupling terminal 123.

The first grip recess 156f may be formed on an outer wall of each of the first sidewall 156b and the third sidewall 156d in a lengthwise direction of the first upper insulation member 156. In more detail, the first grip recess 156f may be formed lengthwise to a predetermined depth on the outer wall of each of the first sidewall 156b and the third sidewall 156d. In other implementations, the first grip recess 156f may be formed at a region where first sidewall 156b and the bottom part 156a contact each other in a lengthwise direction of the first upper insulation member 156. The first grip recess 156f may be formed stepwise at the region where the first sidewall 156b and the bottom part 156a contact each other in the lengthwise direction of the first upper insulation member 156. In general, during an assembling process of a secondary battery, a cell surface or a terminal part of the secondary battery may be pressed and gripped using a gripping device provided in a transfer device, such as a robot, such that the cell may be transferred in various assembling process steps. However, in some cases, the gripped cell surface or the terminal part of secondary battery may be damaged. Therefore, according to embodiments, the first grip recess 156f is formed on the outer wall of each of the sidewalls of the first upper insulation member 156 such that the cell may be conveniently gripped using a transfer device, such as a robot, and then may be transferred to a desired position, thereby improving working efficiency and preventing damage to the secondary battery. For example, in the manufacture of a secondary battery, in order to apply a predetermined coating material to an external surface of the case 140, a cell may be conveniently gripped by a transfer device, such as a robot, and then transferred to a space in which the applying of the coating material is performed. The first grip recess 156f may have any suitable cross-sectional shape, such as a cross-sectional shape of a rectangle, a triangle, a circle or a semi-circle in view of a direction perpendicular to the lengthwise direction of the first upper insulation member 156 as long as the first upper insulation member 156 can be gripped by the gripping device provided in the transfer device, such as a robot. The gripping device may press the cell in a widthwise direction of the second grip recess 133a to transfer the cell to a desired position.

The electrode terminal hole 156g may be formed in the bottom part 156a to allow the first electrode terminal 122 to pass through the electrode terminal hole 156g.

The first protrusion part 156h may be formed to protrude on a top surface of the bottom part 156a in the vicinity of the electrode terminal hole 156g and may be coupled to the first guide groove 124c formed on the bottom surface of the first coupling body part 124a.

The first opening hole 156i may be formed in the bottom part 156a to correspond to the short-circuit plate 158. The first opening hole 156i may have a diameter greater than a diameter of the short-circuit hole 151c of the cap plate 151, thereby allowing the short-circuit plate 158 and the first extension part 125 of the first coupling terminal 123 to contact each other.

The vertical protrusion part 156j may include a plurality of vertical protrusion parts and may be formed to protrude toward an interior side of the space at corner regions formed by the first sidewall 156b and the second sidewall 156c, and the second sidewall 156c and the third sidewall 156d. The vertical protrusion part 156j may support side surfaces of the cover part 157.

The first upper insulation member 156 and the second upper insulation member 155 may be made of a material selected from polypropylene (PP), polyethylene (PE), polyvinyl chloride (PVC), urethane, nylon, and PTFE (for example, Teflon).

The cover part 157 may be detachably coupled to the first upper insulation member 156 so as to cover the extension part 125 of the first coupling terminal 123. The cover part 157 may include a flat region 157a and sidewalls 157b.

The flat region 157a may be formed on an upper portion of the first extension part 125 of the first coupling terminal 123 so as to cover the first extension part 125.

The sidewalls 157b may extend downwardly from ends of the flat region 157a toward the extension part 125. In addition, a vertical projecting groove 157c may be formed at an edge of each of the sidewalls 157b. The vertical projecting groove 157c may be shaped to correspond to the vertical protrusion part 156j so as to allow the vertical protrusion part 156j of the first upper insulation member 156 to be fitted into and fixed to vertical projecting groove 157c. The vertical projecting groove 157c may be formed in the cover part 157 to couple the vertical projecting groove 157c to the vertical protrusion part 156j, thereby improving a coupling force of the cover part 157 and the first upper insulation member 156. In addition, a guide groove 157d accommodating the first coupling part 124 may be formed at one of the sidewalls 157b. The guide groove 157d of the cover part 157 may accommodate one side of the first coupling part 124, thereby improving a fastening force between the cover part 157 and the first coupling terminal 123.

The short-circuit plate 158 may be formed in the short-circuit hole 151c of the cap plate 151. The short-circuit plate 158 may include a round region that is downwardly convex, and an inversion plate having an edge part fixed to the cap plate 151. The short-circuit plate 158 is inverted when the internal pressure of the secondary battery 100 exceeds the set pressure, and protrudes to be upwardly convex, causing short circuiting between the cap plate 151 and the first extension part 125 of the first coupling terminal 123. The short-circuit plate 158 and the cap plate 151 may have the same polarity.

The lower insulation member 159 may be formed between each of the first collector plate 121 and the second collector plate 131 and the cap plate 151, thereby preventing unnecessary short circuiting. The lower insulation member 159 may prevent short circuiting between the first collector plate 121 and the cap plate 151 and short circuiting between the second collector plate 131 and the cap plate 151. In addition, the lower insulation member 159 may be formed between each of the first electrode terminal 122 and the second electrode terminal 132 and the cap plate 151, thereby preventing undesired short circuiting between each of the first electrode terminal 122 and the second electrode terminal 132 and the cap plate 151.

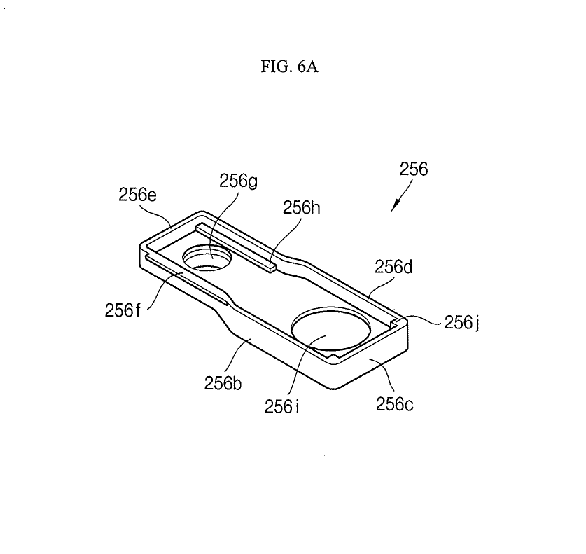

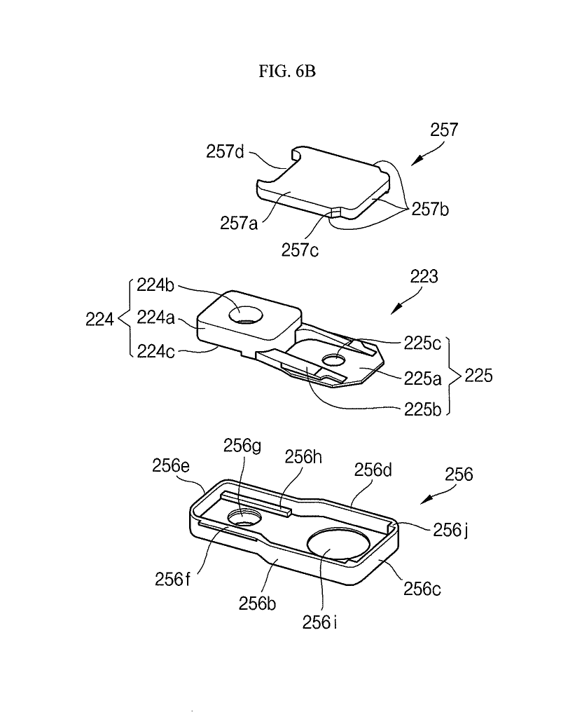

FIG. 6A illustrates a perspective view of an upper insulation member of a secondary battery according to another embodiment, and FIG. 6B illustrates an exploded perspective view showing connections between the upper insulation member, a coupling terminal, and a cover shown in FIG. 6A.

Referring to FIGS. 6A and 6B, the secondary battery according to this embodiment is substantially the same as the secondary battery according to the previous embodiment shown in FIGS. 1 to 5A, except for a configuration of a first upper insulation member 256. More specifically, the secondary battery according to this embodiment is different from the secondary battery according to the previous embodiment shown in FIGS. 1 to 5A with respect to the shape of a first grip protrusion part 256f of the first upper insulation member 256. Thus, the following description will focus on the configuration of the first upper insulation member 256.

The first upper insulation member 256 of the secondary battery according to this embodiment is formed to accommodate a first coupling terminal 223. The first upper insulation member is located between the first coupling terminal 223 and a cap plate (151 of FIG. 2). The first upper insulation member 256 may include a bottom part 256a, a first sidewall 256b, a second sidewall 256c, a third sidewall 256d and a fourth sidewall 256e. In addition, the first upper insulation member 256 may include a grip protrusion part 256f, an electrode terminal hole 256g, a first opening hole 256i and a first protrusion part 256h.

The grip protrusion part 256f may be formed on an outer wall of each of the first sidewall 256b and the third sidewall 256d in a lengthwise direction of the first upper insulation member 256. More specifically, the grip protrusion part 256f may be formed to a predetermined thickness lengthwise on the outer wall of each of the first sidewall 256b and the third sidewall 256d. The grip protrusion part 256f may outwardly protrude from top ends of the first sidewall 256b and the third sidewall 256d in a direction perpendicular to the lengthwise direction of the first upper insulation member 256. The grip protrusion part 256f allows a cell to be conveniently gripped, such as by a robot, and to be transferred to a desired position using a transfer device in the manufacture of a secondary battery. For example, in the manufacture of a secondary battery, in order to apply a predetermined coating material to an external surface of a case, a cell may be gripped by a transfer device, such as a robot, and then transferred to a space in which the applying of the coating material is performed. The first upper insulation member 256 may be gripped by a gripping device provided in a transfer device, thereby improving working efficiency.

As described above, in the secondary battery according to the embodiments, working efficiency during a transfer or coating process can be improved by forming a grip recess or a grip protrusion part in an insulation member and/or a coupling terminal. By forming a grip recess and/or a grip protrusion part in an insulation member and/or a coupling terminal, it may be possible to reduce the likelihood of the secondary battery being damaged during a battery assembling process.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A secondary battery, comprising:
an electrode assembly including a first electrode plate, a second electrode plate, and a separator interposed between the first electrode plate and the second electrode plate;
a first collector plate and a second collector plate electrically connected to the first electrode plate and the second electrode plate, respectively;
a case accommodating the electrode assembly, the first collector plate and the second collector plate;
a cap plate sealing the case;
a first electrode terminal and a second electrode terminal respectively electrically connected to the first collector plate and the second collector plate and penetrating the cap plate;
a first coupling terminal spaced apart from an outside of the cap plate and electrically connected to the first electrode terminal; and
a first upper insulation member provided between the cap plate and the first coupling terminal, the first upper insulation member including a first grip recess extending lengthwise at opposite sides of the first upper insulation member.

2. The secondary battery as claimed in claim 1, wherein the first upper insulation member includes a bottom part and sidewalls extending from edges of the bottom part toward the first coupling terminal.

3. The secondary battery as claimed in claim 2, wherein an upper surface of the bottom part of the first upper insulation member has at least one protrusion part formed thereon.

4. The secondary battery as claimed in claim 3, wherein the cap plate includes a short-circuit hole and a short-circuit plate installed in the short-circuit hole.

5. The secondary battery as claimed in claim 4, wherein the bottom part of the first upper insulation member includes an electrode terminal hole through which the first electrode terminal passes and an opening hole corresponding to the short-circuit plate.

6. The secondary battery as claimed in claim 5, wherein the first coupling terminal includes a coupling part coupled to the first electrode terminal, and includes an extension part extending from the coupling part so as to be adjacent to the short-circuit plate.

7. The secondary battery as claimed in claim 6, wherein at least one guide groove is formed at at least one opposite side of the coupling part, and the protrusion part at the upper surface of the bottom part of the first insulation member is engaged with the guide groove.

8. The secondary battery as claimed in claim 6, further comprising a cover part provided to cover the extension part.

9. The secondary battery as claimed in claim 2, wherein the first grip recess is located at each of the sidewalls in a lengthwise direction of the first upper insulation member.

10. The secondary battery as claimed in claim 9, wherein a cross-sectional shape of the first grip recess is one selected from a polygon, a circle, and a semi-circle with respect to the lengthwise direction of the first upper insulation member.

11. The secondary battery as claimed in claim 2, wherein the first grip recess is located at a region where the sidewall and the bottom part contact each other in the lengthwise direction of the first upper insulation member.

12. The secondary battery as claimed in claim 11, wherein a cross-sectional shape of the first grip recess is one selected from a polygon, a circle, and a semi-circle with respect to the lengthwise direction of the first upper insulation member.

13. The secondary battery as claimed in claim 1, wherein the first upper insulation member includes one selected from polypropylene (PP), polyethylene (PE), polyvinyl chloride (PVC), urethane, nylon, and PTFE.

14. The secondary battery as claimed in claim 1, wherein further comprising a second coupling terminal spaced apart from the cap plate and coupled to the second electrode terminal.

15. The secondary battery as claimed in claim 14, further comprising a second upper insulation member between the cap plate and the second coupling terminal.

16. The secondary battery as claimed in claim 15, wherein the second coupling terminal has a second grip recess located at opposite sides of the second coupling terminal in a same direction in which the first grip recess is formed.

17. The secondary battery as claimed in claim 12, wherein the first upper insulation member and the second upper insulation member include one selected from polypropylene (PP), polyethylene (PE), polyvinyl chloride (PVC), urethane, nylon, and PTFE.

18. A secondary battery comprising:
an electrode assembly including a first electrode plate, a second electrode plate, and a separator interposed between the first electrode plate and the second electrode plate;
a first collector plate and a second collector plate electrically connected to the first electrode plate and the second electrode plate, respectively;
a case accommodating the electrode assembly, the first collector plate and the second collector plate;
a cap plate sealing the case;
a first electrode terminal and a second electrode terminal respectively electrically connected to the first collector plate and the second collector plate and penetrating the cap plate;
a first coupling terminal spaced apart from the cap plate and electrically connected to the first electrode terminal; and
a first upper insulation member between the cap plate and the first coupling terminal, the first upper insulation member including a grip protrusion part extending lengthwise at both sides of the first upper insulation member.

19. The secondary battery as claimed in claim 18, wherein the first upper insulation member includes a bottom part and sidewalls extending from edges of the bottom part in a first direction.

20. The secondary battery as claimed in claim 19, wherein the grip protrusion part outwardly protrudes from a top end of the sidewall and is perpendicular to the lengthwise direction.
